(19) United States
(12) Patent Application Publication
(10) Pub. No.: US 2011/0305245 A1
(43) Pub. Date: Dec. 15, 2011

(54) NETWORK SWITCH

(75) Inventors: YOSHIHISA TANAKA, Nagareyama (JP); Kazuaki Tsuchiya, Funabashi (JP)

(73) Assignee: ALAXALA Networks Corporation

(21) Appl. No.: 13/158,049

(22) Filed: Jun. 10, 2011

(30) Foreign Application Priority Data
Jun. 11, 2010 (JP) 2010-133491

(51) Int. Cl. H04L 12/56

(52) U.S. Cl. 370/401

(57) ABSTRACT

A network switch including a plurality of switches are mutually connected operable as one switch stack with maintenance operation to be logically performed, and wherein the switch stack can be constructed by connecting a plurality of switches having different enclosing conditions. A stackable switch operable under one of the following two operation references of switches: only one or a plurality of switches having the largest enclosing condition play as a master and the backup and if communication cannot be made or backup and the switch having the largest enclosing condition serving as an alternative switch does not exist, it is regarded that the switch stack entered an operation incapable state; and the switch operates in accordance with the smallest enclosing condition among all of the switches constructing the stack.

### INCORPORATION BY REFERENCE

The present application claims priority from Japanese application JP2010-133491 filed on Jun. 11, 2010, the content of which is hereby incorporated by reference into this application.

### BACKGROUND OF THE INVENTION

1. Field of the Invention

The invention relates to a network switch including a stackable switch and, more particularly, to a network switch in which a switch stack is constructed by making a stackable connection among switches having different enclosing conditions.

2. Description of the Related Arts

A stackable function is such a technique that a plurality of switches having the stackable function are connected by LAN cables, optical cables, or stackable dedicated cables and are virtually made operative as one switch stack. As features of such a technique, as disclosed in the Official Gazette of JP-A-2002-217935, there can be mentioned such features that a redundant construction can be easily formed, a multiport line collection can be realized by joining the switch stack, and even if the switch stack was joined, an operation maintenance can be theoretically carried out in a manner similar to the case of one switch.

According to the existing technique, the stackable function is applied only to the apparatuses having the same enclosing condition. This is because in order to hold a shortest path, setting contents such as common VLAN (virtual LAN) information, transfer information of Layer 2, and the like are copied among a plurality of switches and a transfer process is realized in each switch. Therefore, the stackable function is not applied among the switches having different enclosing conditions. In this case, there is such a problem that a flexible building of a network in which the switches having the different enclosing conditions are freely combined cannot be performed and the network equipment property cannot be effectively utilized.

Particularly, in the stackable function as a function of, mainly, a box type switch (e.g., catalyst 3750), there is such a problem that a switch stack cannot be constructed between a chassis type switch (with swappable switch module cards) in which a casing and an interface module can be combined and used and which has a large expandability and the box type switch in which the expandability is limited because an interface has inherently been installed or between the chassis type switch and a box type switch having a different enclosing condition, or the like.

For example, in a state where a switch stack is constructed by using the maximum number of box type switches and operates, in the case where the number of terminals connected to the network increases and the maximum number of ports which are simultaneously connected in the switch stack exceeds the maximum enclosing condition, the switch is joined. At this time, in the case of joining one box type switch, it cannot be joined to the switch stack which has already been being operated. Therefore, it is necessary to construct the network by a technique such as a spanning tree or the like or to newly construct another switch stack different from the present switch stack. In any of the above cases, the number of switches to be managed by the operation maintenance logically changes from 1 to a plural number of 2 or more. Subsequently, in the case of perfectly shifting to an upper apparatus having a large enclosing condition such as a chassis type switch or the like, the number of apparatuses to be managed by the operation maintenance can be come down to 1. However, since the apparatuses cannot be made operative by the switch stack construction with the switch which is used at present, the existing switch property cannot be effectively utilized.

As a countermeasure against a case where the number of switches exceeds the enclosing condition of the maximum number of ports which are simultaneously connected during the operation of a certain chassis type switch, joining of the box type switch or the chassis type switch is considered. However, in the related arts, since the switches cannot be made operative as a switch stack in any of those cases, it is necessary to construct the redundant construction by the technique such as a spanning tree or the like.

### SUMMARY OF THE INVENTION

In the related arts, there is such a problem that the switch stack cannot be constructed by the switches having different enclosing conditions as in the case where the box type switch and the chassis type switch are provided. It is, therefore, an object of the invention to provide a switch having a stackable function which can operate as a flexible switch stack using the stackable function by one or a plurality of switches and one or a plurality of switches having enclosing conditions different from those of such switches.

To accomplish the above objects, according to the invention, there is provided a switch which is connected to at least one or more other switches having different enclosing conditions and virtually constructs one switch stack, comprising: a frame transmission/reception control unit for receiving a frame for stack management including information showing the enclosing conditions of the other switches from the one or more other switches constructing the switch stack; and a stackable processing unit for comparing the enclosing conditions of the other switches with an enclosing condition of its own switch on the basis of the information showing the enclosing conditions of the other switches included in the frame for stack management received by the frame transmission/reception control unit and information showing the enclosing condition of its own switch and selecting the switch having the largest enclosing condition as a master apparatus for managing the switch stack.

According to the invention, in the stackable function, a plurality of switches having different enclosing conditions are connected and can be made operative as a switch stack. Thus, when the network which is operating is expanded, the existing property can be efficiently utilized while maintaining the stackable function without perfectly shifting to an upper apparatus.

Other objects, features and advantages of the invention will become apparent from the following description of the embodiments of the invention taken in conjunction with the accompanying drawings.

### BRIEF DESCRIPTION OF THE DRAWINGS

FIG. 1A is a diagram showing a constructional example of a switch stack in an embodiment;

FIG. 1B is an explanatory diagram of a state management of a network for stackable control in the embodiment;

FIG. 1C is an explanatory diagram of a Layer-2 relay using a trunk port function in the embodiment;

FIG. 1D is an explanatory diagram of a Layer-2 relay using a ULAN tunneling function in the embodiment;

FIG. 1E is an explanatory diagram of a Layer-3 relay using the trunk port function in the embodiment;

FIG. 1F is an explanatory diagram in the case where a link aggregation over switches has been set in the switch stack in the embodiment;

FIG. 2 is a constructional example of a box type switch having a stackable function in the embodiment;

FIG. 3 is a constructional example of a chassis type switch having a stackable function in the embodiment;

FIG. 4A is an explanatory diagram of a format a frame for stackable management in the embodiment;

FIG. 4B is an explanatory diagram (1/2) of each data in the format of the frame for stackable management in the embodiment;

FIG. 4C is an explanatory diagram (2/2) of each data in the for at of the frame for stackable management in the embodiment;

FIG. 5 is a flowchart for a master selection in a state where a plurality of switches having different enclosing conditions are physically connected in the embodiment;

FIG. 6 is a flowchart in the case where a relationship of master and servant cannot be realized in the master selecting step or when a switch is newly participated after the elapse of a predetermined time in the embodiment;

FIG. 7A is an explanatory diagram showing an example of a aster selection reference value in FIG. 1A;

FIG. 7B is an explanatory diagram showing an example in the case where a priority is changed in FIG. 7A;

FIG. 8 is an explanatory diagram of a control information table held in a stackable information management table control unit 214 in the embodiment; and

FIG. 9 is a diagram showing a constructional example of a switch stack in the related arts.

### DESCRIPTION OF EMBODIMENTS

An embodiment of the invention will be described in detail hereinbelow with reference to the drawings.

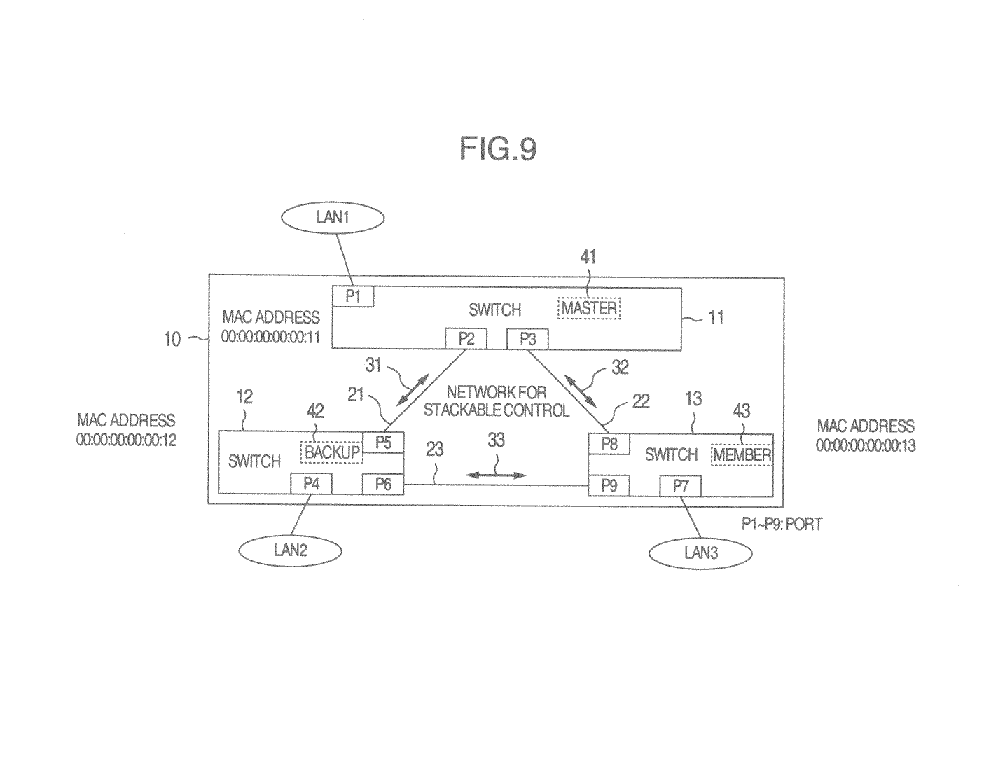

FIG. 9 is a diagram showing a constructional example of a switch stack in the related arts.

A switch stack 10 is constructed by three stackable switches (hereinbelow, called “switches”) 11 to 13. A LAN 1 is enclosed from a port for the user (hereinbelow, the port for enclosing the LAN of the user is called “port for the user”) P1 of the switch 11. A LAN 2 is enclosed from a port for the user P4 of the switch 12, ALAN 3 is enclosed from a port for the user P7 of the switch 13. The switch stack 10 operates as if it was virtually seen as one switch from each LAN.

The three switches 11 to 13 are the switches having the same enclosing condition and are connected to stack ports (hereinbelow, the port for enclosing a network for stackable control is called “stack port”) P2, P3, P5, P6, P8, and P9 by cables 21, 22, and 23, respectively, thereby constructing the network for stackable control in, mainly, a ring construction. In the related arts, a plurality of switches can be connected so long as they are the switches constructed by parts having the same enclosing condition.

Since the switch stack 10 operates as one virtual switch, the switches 11 to 13 mutually update information as indicated by a set of control frames 31 to 33 in the drawing, select roles serving as one master and other members, and operate. The role of the master is to manage states of the members, states of their ports, and traffics with respect to the whole switch stack 10. The member plays a role for notifying the master of management information by taking a state change as an opportunity. If the switch which plays the role of the master enters an operation incapable state due to an internal obstruction or if communication from another switch cannot be made due to an obstruction of a line connected to the master, the remaining switches execute an initialization by a reactivation or the like and a master is newly selected again. Therefore, an interruption of the communication occurs. In order to shorten such a communication interruption time, the switch which plays the role of a backup is preliminarily determined. Thus, even if the case where the switch which plays the role of the master becomes an obstruction and the communication cannot be made occurred, the communication interruption time can be shortened.

In FIG. 9, at the time of the activation of the switch stack 10, as a result of that the switches mutually updated the information as indicated by the frames 31 to 33, for example, the switch having a smallest MAC address is set to the master, and the switch having the second smallest MAC address is set to the apparatus for backup. Thus, as a role of the switch 11 “master” 41 is selected. Similarly, as a role of the switch 12, “backup” 42 is selected. Consequently, a role of the switch 13 is “member” 43.

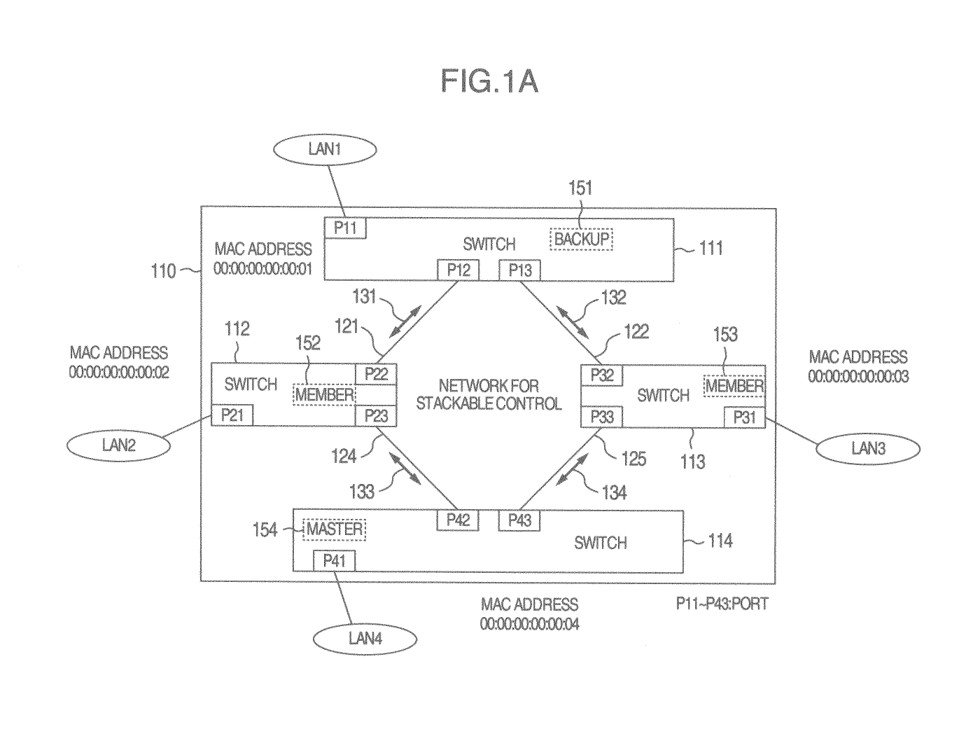

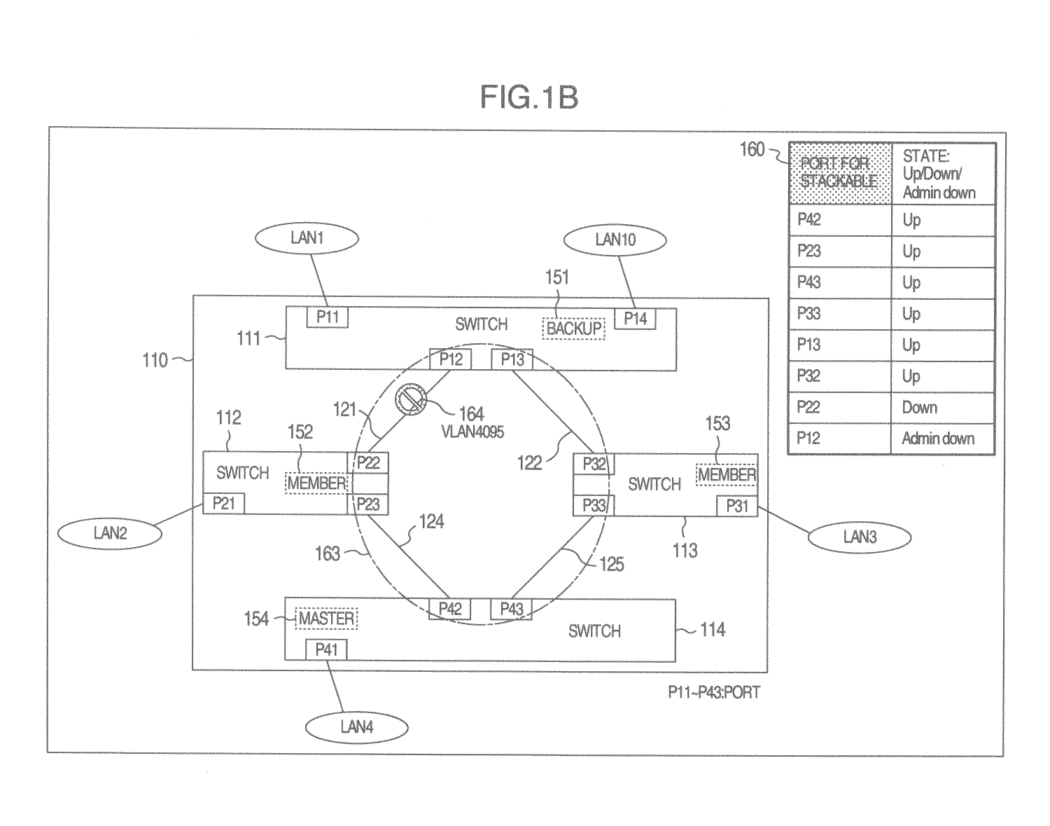

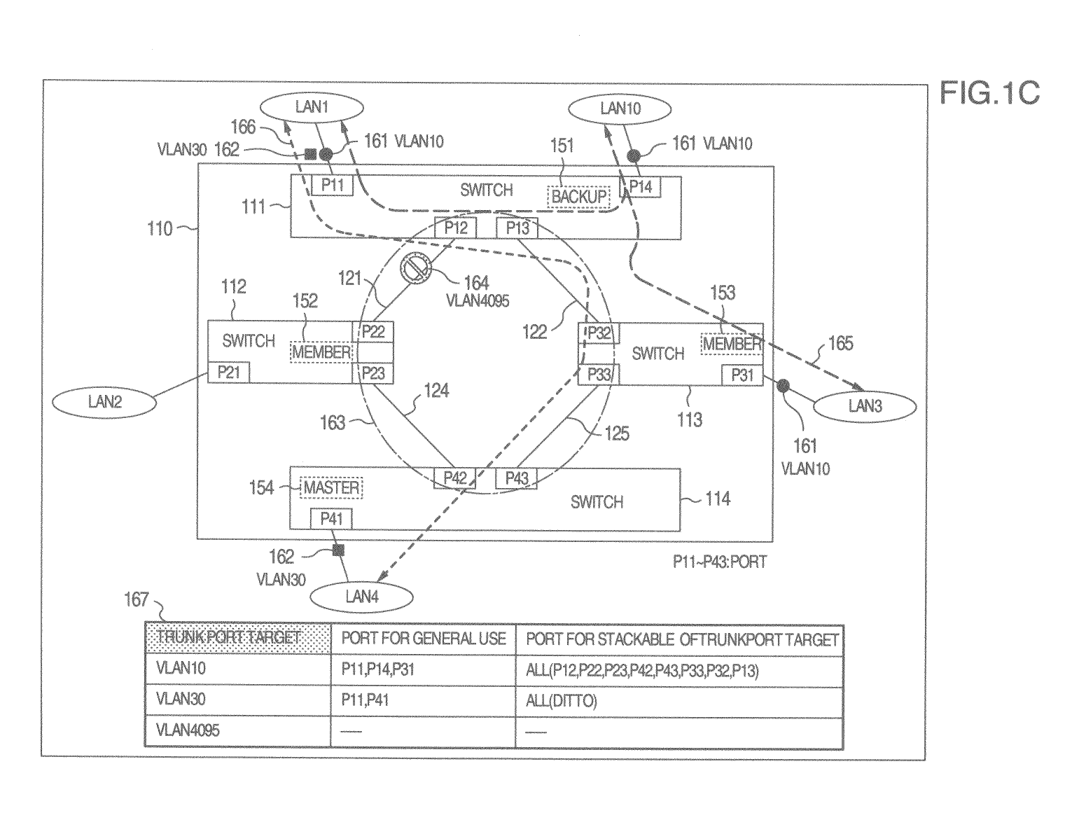

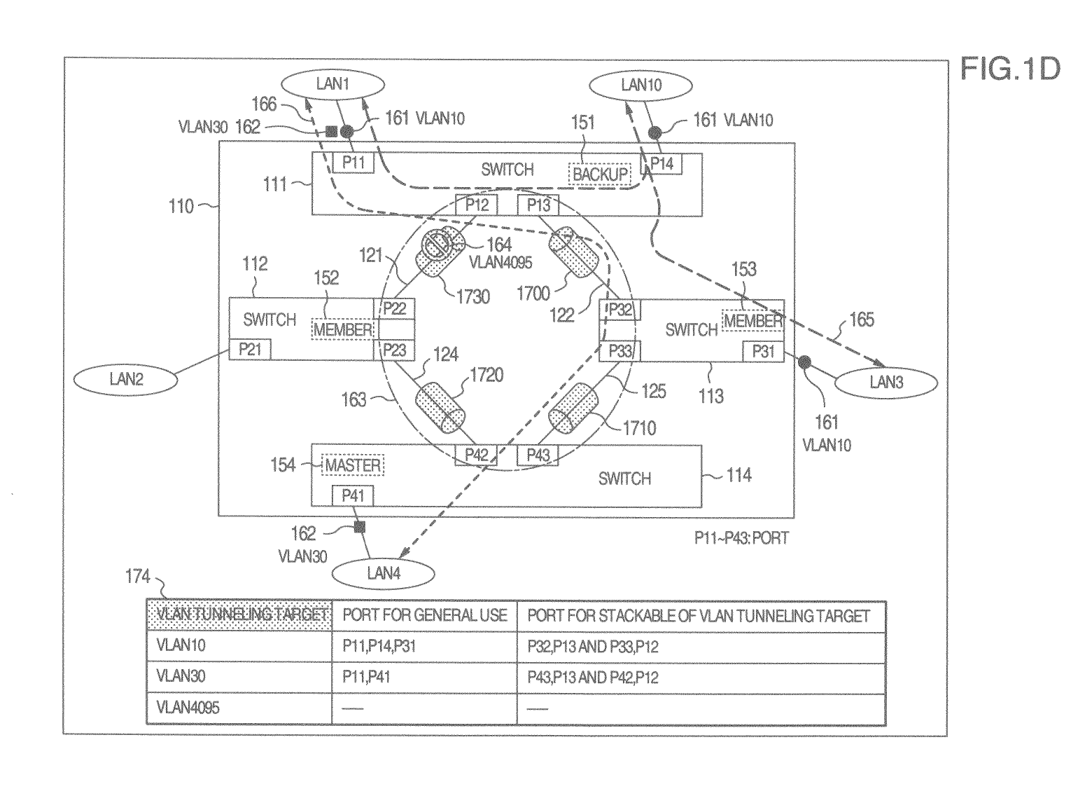

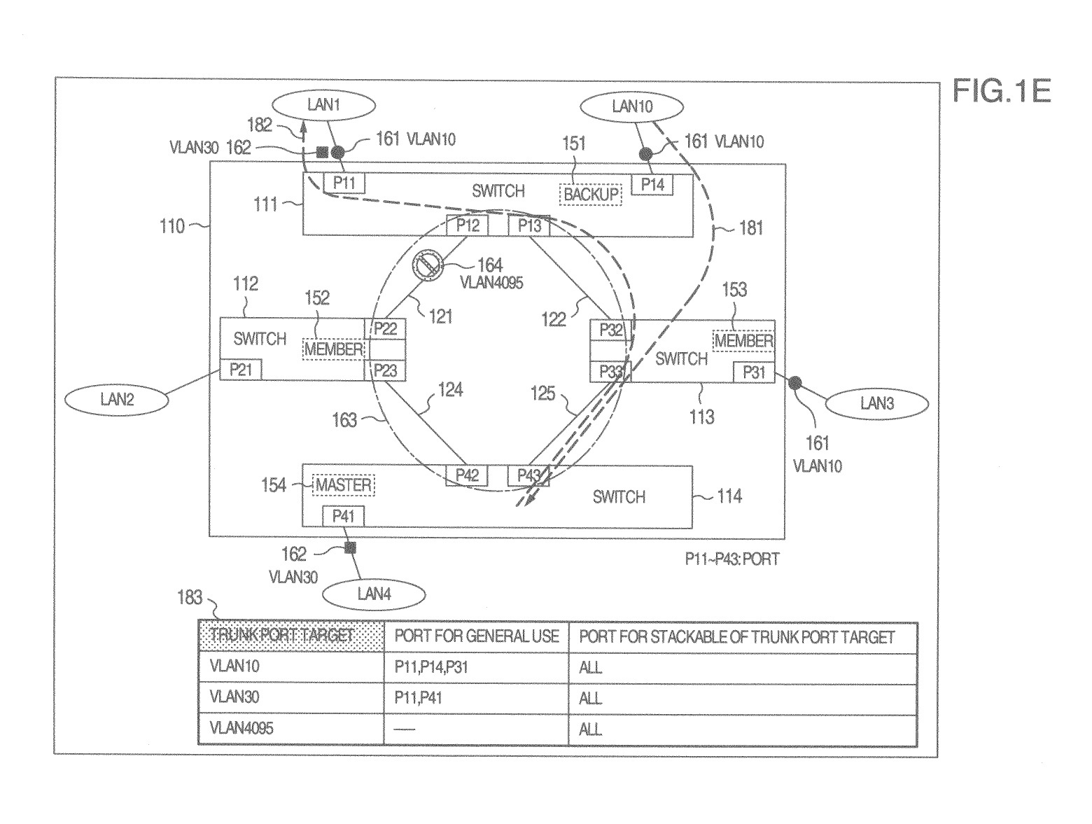

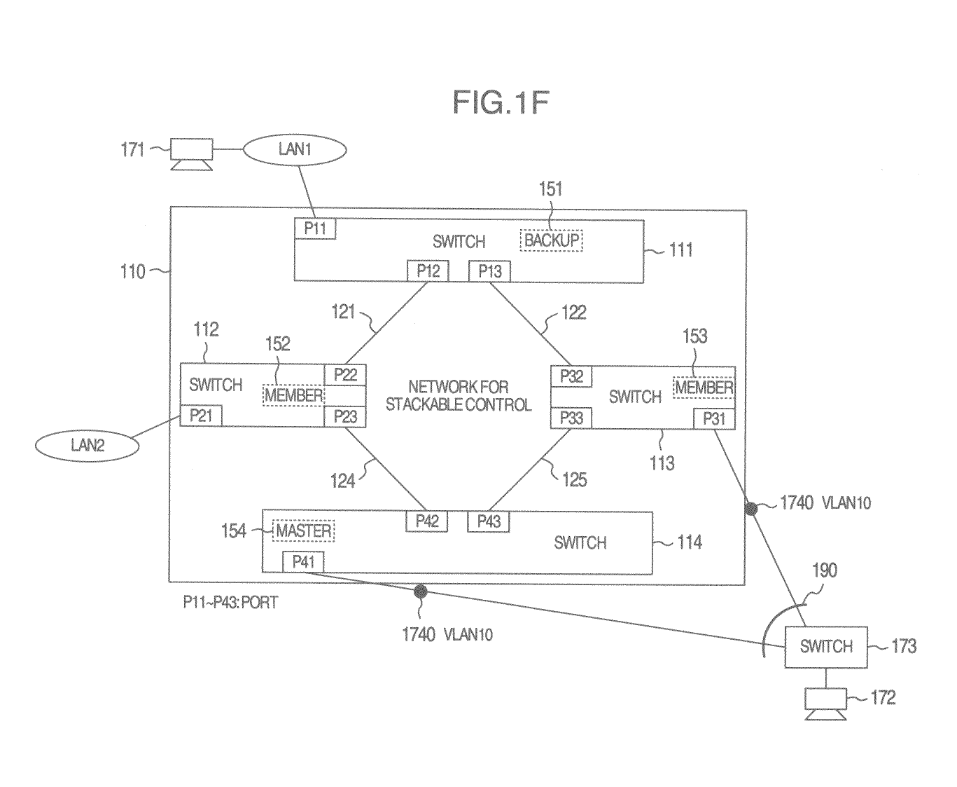

FIG. 1A is a diagram showing a constructional example of a switch stack in the embodiment.

A switch stack 110 is constructed by four stackable switches (hereinbelow, also called “switches”) 111 to 114. The LAN 1 is enclosed from a port for the user (hereinbelow, the port for enclosing the LAN of the user is called “port for the user”) P11 of the switch 111. The LAN 2 is enclosed from a port for the user P21 of the switch 112. The LAN 3 is enclosed from a port for the user P31 of the switch 113. The LAN 4 is enclosed from a port for the user P41 of the switch 114. The switch stack 110 operates as if it was virtually seen as one switch from each LAN.

Unlike the related art described in FIG. 9, as for the switches 111 to 114 constructing the switch stack 110 in the embodiment, enclosing condition of at least one of them is different from those of the other switches. In the embodiment, it is assumed that the switch 114 is a switch having the largest enclosing condition. The switches 111 to 114 are connected to stack ports (hereinbelow, the port for enclosing the network for stackable control is called “stack port”) P12, P13, P22, P23, P32, and P33 by cables 121, 122, 124, and 125, respectively, thereby constructing the network for stackable control in, mainly, the ring construction. The switches 111 to 114 exchange information by using a frame for stackable management, which will be described hereinafter (131 to 134). By newly constructing the switch stack 110 by newly connecting the switch 114 (switch of the large enclosing condition) in FIG. 1A to the switches 11 to 13 in the related art described in FIG. 9, the existing property can be also efficiently utilized.

Although the stack ports of the switches 111 to 114 are dedicated ports for use as a stackable function, the port for the user can be also used as a stack port by inputting a configuration command showing that the port is used with the stackable function as a port for the user. As a cable, an optical fiber cable, a twisted pair cable, or the like may be used and a cable type is not limited.

In FIG. 1A, at the time of the activation of the switch stack 110, the switches 111 to 114 transmit and receive frames for stackable management 131 to 134, mutually exchange information, and decide the roles, respectively. Since the switch 114 has an enclosing condition larger than those of the other switches 111 to 113, “master” 154 is selected as a role. It is assumed that the switches 111 to 113 have the same enclosing condition. Therefore, the role of the switch 111 having an MAC (Media Access Control) address of the smallest value is “backup” 151. The roles of the switches 112 and 113 are “member” 152 and 153. In the embodiment, as a selecting condition of the apparatus which plays the role of the backup, the switch having the same enclosing condition as that of the master or the second large enclosing condition subsequent to the master is selected.

The selecting condition of the apparatus which plays the role of the master and the apparatus which plays the role of the backup in the embodiment will now be summarized. When the switch stack constructed by a plurality of two or more switches is constructed, the switch having the largest enclosing condition is selected as a master, at the same time, the switch having the same enclosing condition as that of the master or the second largest enclosing condition is selected as a backup, and the switch stack operates by a hot standby with the master. As for the third and subsequent members, in the case where the switch of the master or backup enters the operation incapable state due to the internal obstruction or the communication from another switch cannot be made due to the obstruction of the line connected to the master or backup, the switch which plays the role of the backup is newly selected. At this time, the switch having the largest enclosing condition among the members is selected. Owing to this method, when the apparatus of the master enters a state where it cannot communicate due to the internal obstruction or the like, the communication interruption time as a switch stack is shortened and the switch having the large enclosing condition takes over the role of the master, thereby enabling the large enclosing condition to be always maintained as a switch stack.

Upon designation of the master and backup, they can be preset by the configuration command. Similarly, from which switches the third and subsequent members as backup candidates are selected can be also preset, that is, its selecting order can be also preset based on the priority.

Further, in the embodiment, when the apparatus of the master enters a state where it cannot communicate due to the internal obstruction or the like, in the case of shifting the role of the master from the switch 114 having the large enclosing condition to the switch as a backup, one of the following two methods can be selected.

### (Method 1)

It is assumed that as a master, the switch 114 having the large enclosing condition and only the switch having the same enclosing condition as that of the switch 114 play the role of the backup. If none of the switches having the same enclosing condition as that of the switch 114 exists due to the master obstruction, the switch stack is set into the operation incapable state.

### (Method 2)

The enclosing condition of the switch 114 is preset to a low enclosing condition in accordance with the switch having the small enclosing condition in the whole switch stack.

When the stack apparatus of the master enters a state where it cannot communicate, since it is necessary to shift the role of the master to the stack apparatus serving as a backup, it is necessary to register path information held in the stack apparatus of the master to the stack apparatus which becomes the master (the stack apparatus which was the backup). Therefore, if the enclosing condition of the stack apparatus of the backup is smaller than that of the stack apparatus of the master, when the role of the master is shifted, there is a possibility that the path information which cannot be registered into the stack apparatus which newly becomes the master appears due to a difference of the enclosing conditions.

However, if the foregoing (Method 1) is used, since the switch having the role of the backup has the same enclosing condition as that of the switch of the master, even if the role of the master is shifted, all of the path information can be registered into the stack apparatus which newly became the master. Even when the foregoing (Method 2) is used, since the enclosing condition of the switch of the master is et in accordance with the switch having the small enclosing condition, even if the role of the master is shifted, all of the path information can be registered into the stack apparatus which newly became the master.

In the embodiment, the user is enabled to select the foregoing two methods by the configuration command, an MIB (Management Information Base), or the like. If the foregoing (Method 1) is set to a default and when nothing is set from the user, the apparatus operated under the conditions of (Method 1). As a default, the enclosing condition indicates the maximum number of MAC address entries. Whether or not the maximum number of ARP (Address Resolution Protocol) entries and the maximum number of path entries, which will be described hereinafter, are also included in targets as enclosing conditions can be set by the configuration command or the MIB.

The switches 111 to 114 may be either the box type switches or the chassis type switches, which will be described hereinafter.

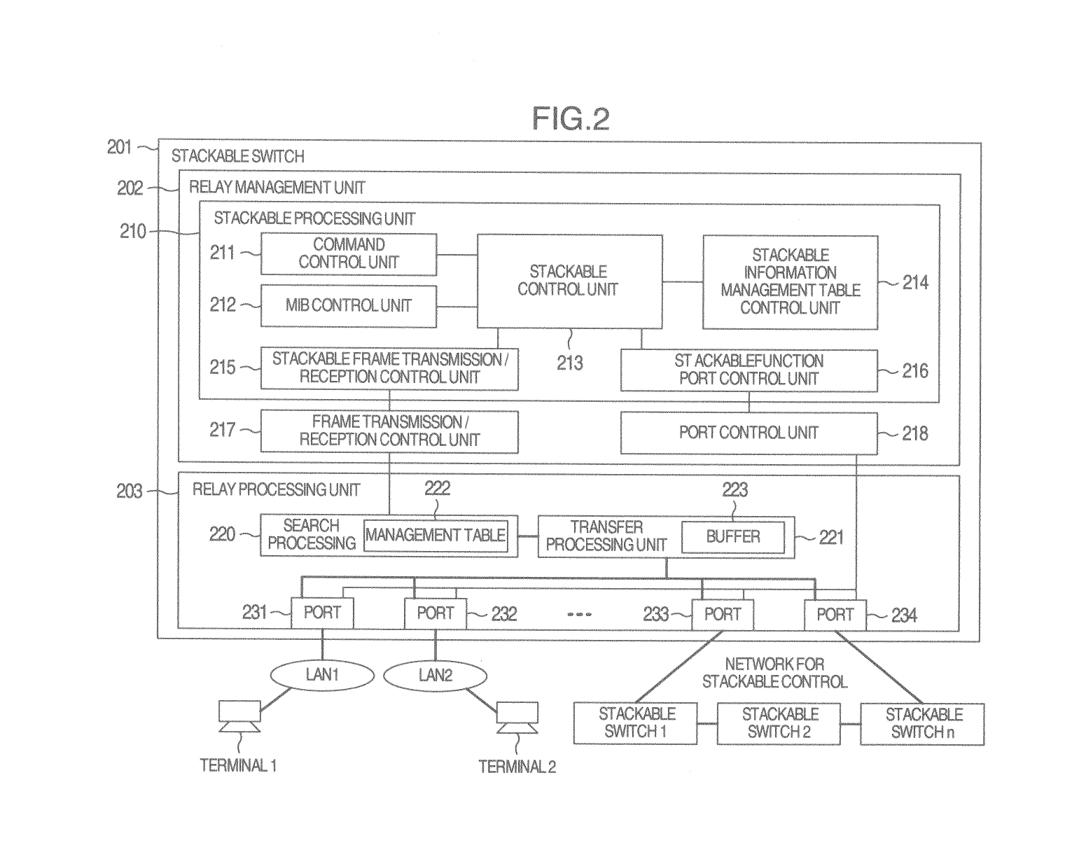

FIG. 2 is a constructional diagram of a box type switch having a stackable function in the embodiment. A switch 201 is constructed by a relay management unit 202 for forming VLAN information to perform a frame transfer of Layer 2, Layer-3 path information to perform a packet transfer of Layer 3, and the like and making a setting to a relay processing unit 203; and the relay processing unit 203 for performing the frame transfer.

The relay processing unit 203 has a plurality of physical ports 231 to 234, a search processing unit 220; and a transfer processing unit 221. The physical port 231 encloses the LAN 1 and a terminal 1 as ports for the user. The physical port 232 encloses the LAN 2 and the terminal 2 as ports for the user. Similarly, the physical ports 233 and 234 are connected to switches 1 to n as stack ports. There is also a case where the dedicated port which is used only to stack is used as a stack port. The port for the user can be also used as a stack port by inputting the configuration command showing that the port is used with the stackable function as a port for the user. Therefore, the number of constructions of the ports for the user and the stack ports is not limited.

In the search processing unit 220, a VLAN (Virtual LAN) is defined so that each of a plurality of physical ports is handled as a logical port which is identified by a VLAN ID (Virtual LAN Identification), and their contents can be held in a management table 222. A frame which is received from each port in which the VLAN has been defined can be also limited and transferred to another port of the same VLAN by the transfer processing unit 221. When the frames are received through the ports 231 to 234, by learning information of transmitting source addresses of the received frames and reception port information by the search processing unit 220, a correspondence relation between a destination address of the frame which is transmitted and a transmission port is held in the management table 222, and at the time of the frame transfer, the frame is transmitted to the port or disposed. A buffer 223 is a memory area for temporarily storing the frame which is transmitted or the received frame until the transferring process is executed upon transmission and reception of the frame.

The relay management unit 202 has a stackable processing unit 210, a frame transmission/reception control unit 217, and a port control unit 218.

The frame transmission/reception control unit 217 controls the frame which is transmitted and received by the switch 201. The Layer-2 control frame received by each port is classified into a control frame on a function unit basis and distributed to each function module by the frame transmission/reception control unit 217.

In the case where a frame for stackable management for controlling the stackable function was received, it is notified to the stackable frame transmission/reception control unit 215 of the stackable processing unit 210. The stackable frame transmission/reception control unit 215 handles all of the transmission/reception frames which are handled by the stackable processing unit 210. The frame for stackable management is notified to a stackable control unit 213. In the stackable control unit 213, the contents of the frame for stackable management are confirmed. If they are contents of a response of a command inputted from the user, they are notified to a command control unit 211 and information of the command response is displayed to the user. In the case of a response of a life and death check from the master to the backup or member, a check result is registered into a control information table 800 of a stackable information management table control unit 214, which will be described hereinafter.

In the case of performing a shutdown of the port, i.e. Administration down, information of the port which is shut down is notified to the port control unit 218 of the apparatus through a stackable function port control unit 216. The port control unit 218 makes such port control that the port is shut down or not with respect to all of the physical ports of the switch 201. The stackable function port control unit 216 will be described as an example with reference to FIG. 1B.

The command control unit 211 of the stackable processing unit 210 makes initial setting by the user and controls commands upon operation with respect to the stackable function and notifies the stackable control unit 213 of them. The stackable control unit 213 which received the initial settings by the user and the control information upon operation with respect to the stackable function notifies the stackable information management table control unit 214 of such information and holds.

When an up/down notification of the stack port is received from each of the switch groups connected to the ports 233 and 234 or when the operation incapable state of the switch under management of the stackable control unit 213 is detected, an MIB control unit 212 controls so as to notify the user or terminal of such information. For example, control is made in such a manner that information about up/down of the stack port and the operation incapable state of the switch is preset into the MIB so that it can be confirmed from the user, it is displayed to an LED of the relevant port or is displayed to a display screen of the terminal connected to the switch 201, or the like. Means for notifying is not limited.

The switch 201 is constructed as mentioned above.

FIG. 1B is an explanatory diagram of a port state management of the network for stackable control based on the construction of FIG. 1A.

The stackable function port control unit 216 in FIG. 2 manages the port state, thereby allowing communication to be smoothly made with respect to, mainly, the network for stackable control connected in a ring shape. Specifically speaking, the state management of the stack port is made so as not to cause a loop development in the network for stackable control.

In FIG. 1B, there are eight ports P12, P22, P23, P42, P43, P33, P32, and P13 as stack ports constructing a network for stackable control 163 forming a VLAN 4095 and a ring-shaped network is constructed by them. In this state, if the apparatus which was finally activated among the switches 111, 112, 113, and 114 transmits, for example, a message of data for master selection as a kind of frame for stackable management, its packet loops. Therefore, a shutdown (hereinbelow, also called “non-operating state (AdminDown)” is virtually performed to the relevant port so as not to cause the loop. In FIG. 1B, it is assumed that the switch 111 which was finally activated has received from the stack port P12 the message of the data for master selection transmitted from the stack port P13, and a state where the port P12 has been set into the non-operating state is shown by 164. All port states of the stack ports when seen from the master are shown in a table 160.

The above construction will be explained with reference to FIG. 2. In the case where each switch itself received the message of the data for master selection transmitted by itself, it is notified to the stackable function port control unit 216 from the stackable control unit 213 and is notified to the port control unit 218 so that the stack port of its own apparatus which received the message of the data for master selection is set into the non-operating state. The port control unit 218 executes the shutdown process of the relevant physical port. After that, the stackable function port control unit 216 which received a message showing a completion of the shutdown process notifies the stackable control unit 213 of it and transmits the message of the data for master selection in which the port number information by which the relevant port has been set into the non-operating state to another switch.

After the master was selected, the switch of the selected master manages the stack port set in the non-operating state. Specifically speaking; in the case where the obstruction of the port, cable, or switch is detected by a health check or an obstruction notification from each switch, the port is reset from the non-operating state and returned to a port UP state (operating state) in order to assure a communication path to the master.

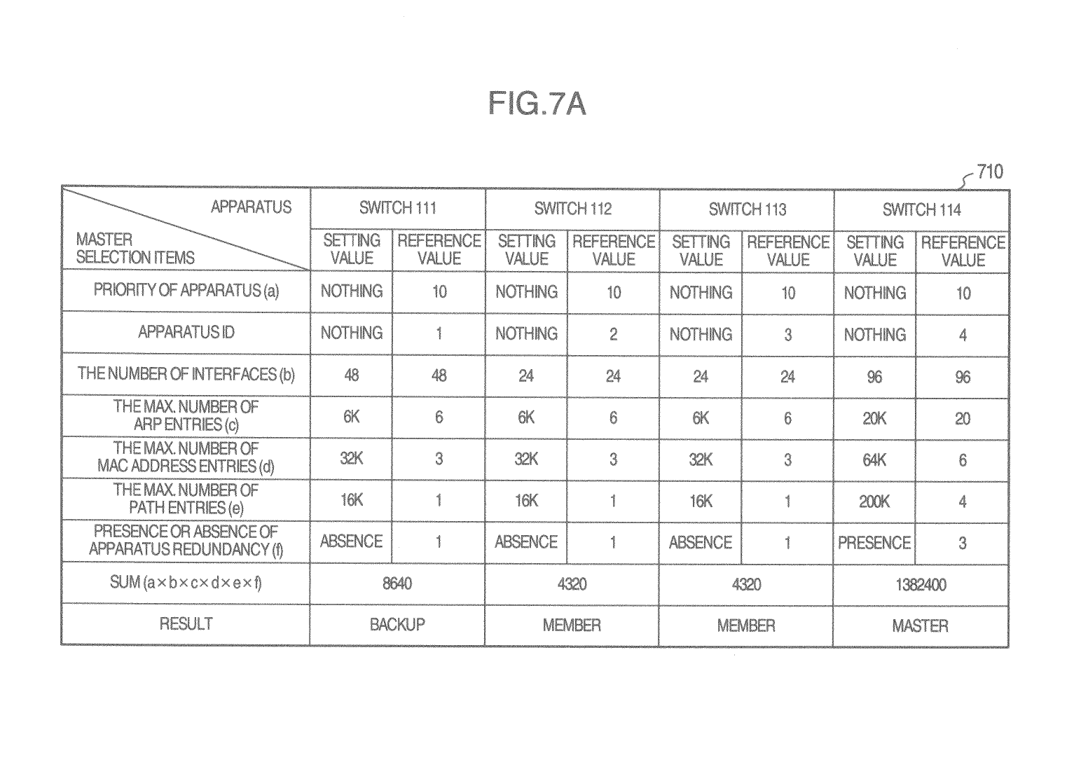

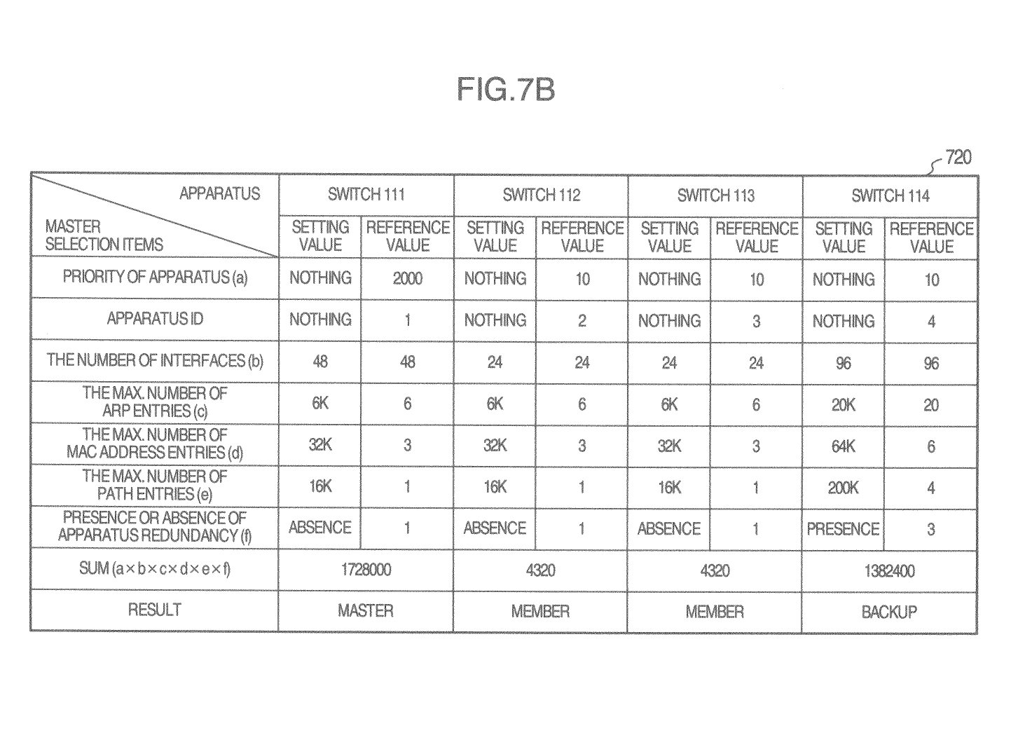

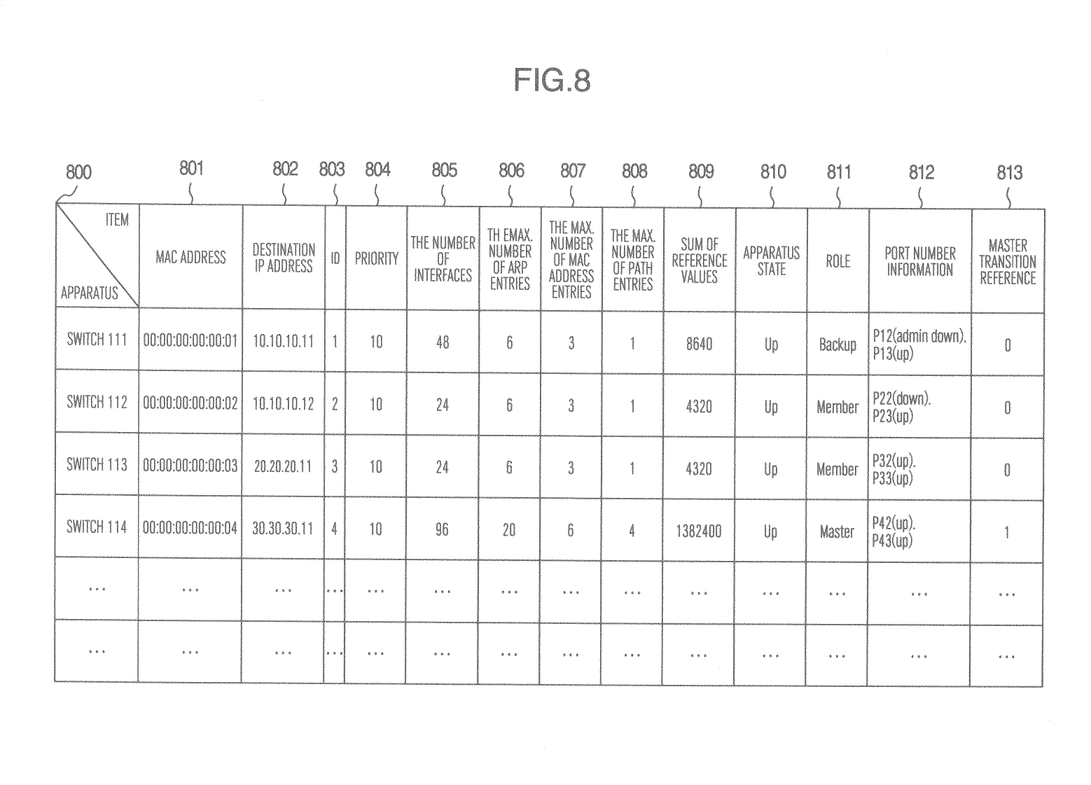

FIG. 8 is an explanatory diagram of the control information table 800 held in the stackable information management table control unit 214 in FIG. 2 in the embodiment. The control information table 800 is a table for managing the information regarding each stack apparatus constructing the network for stackable control. An axis of ordinate indicates each stack apparatus and an axis of abscissa indicates each data which is managed. When the message for master selection is received, an MAC address 801, a destination IP address 802, an apparatus ID 803, a priority 804 of the apparatus, the number of interfaces 805, the number of ARP entries 806, the number of MAC address entries 807, and the maximum number of path entries 808 are stored on the basis of information included in the message for master selection. A sum of reference values is calculated and stored into a reference value sum 809 and its role 811, respectively. A result of the health check is stored into an apparatus state 810. Further, as a state of the network for stackable control, port number information 812 indicative of a port number and its life and death state is defined. A result regarding the port number information in the health check response is also stored. A master transition reference in the case where the master entered a state where it cannot communicate due to an obstruction is shown by 813 and will be described hereinafter with reference to FIG. 7.

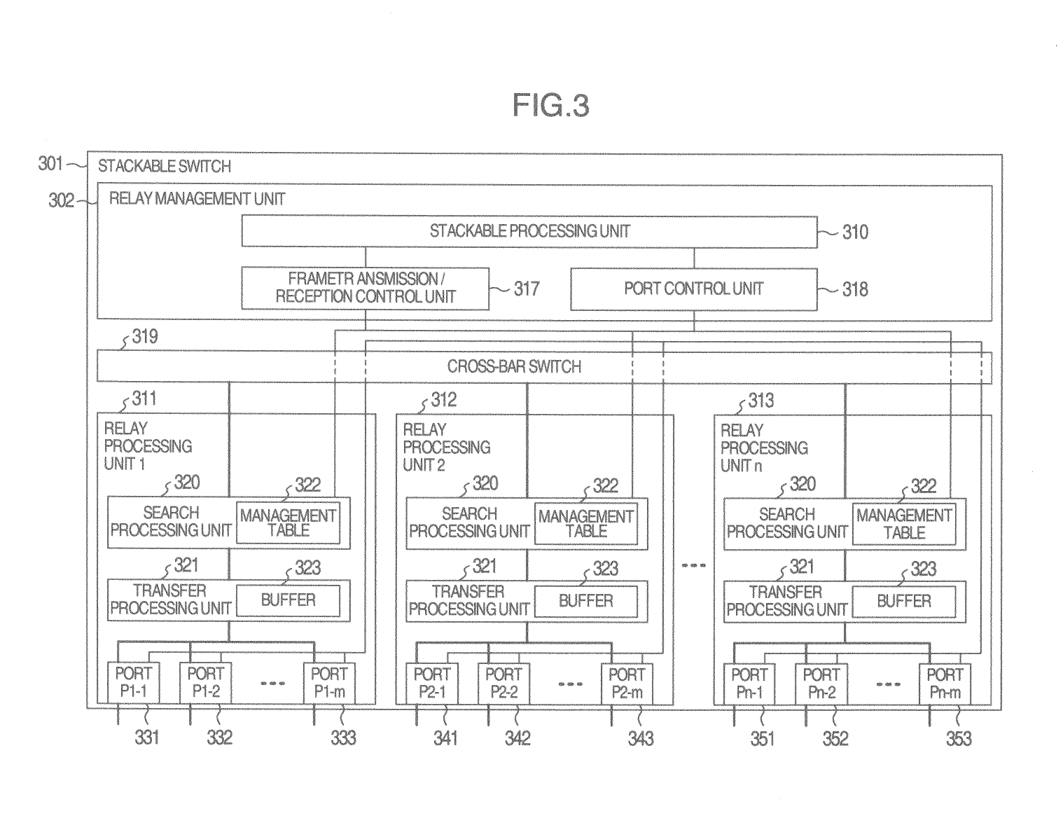

FIG. 3 is a constructional example of a chassis type switch having the stackable function in the embodiment. A switch 301 is divided into a relay management unit 302 for forming VLAN information to perform a frame transfer of Layer 2, Layer-3 path information to perform a packet transfer of Layer 3, and the like and making a setting into a plurality of relay processing units 311 to 313; and the plurality of relay processing units 311 to 313 for performing the frame transfer. The plurality of relay processing units (1 to n) 311 to 313 are connected to a cross-bar switch 319. The number of relay processing units is not limited. The relay management unit 302 has substantially the same construction as that of the relay management unit 202 in FIG. 2 mentioned above and has a stackable processing unit 310, a frame transmission/reception control unit 317, and a port control unit 318. Each of the above control units executes processes similar to those of the control units having the same names as those in FIG. 2 and makes a setting into a plurality of relay processing units.

The relay processing unit-1 311 has: a plurality of physical ports 331 to 333; a search processing unit 320, and a transfer processing unit 321. The relay processing unit-1 311 has m ports P1-1 to P1-m. Similarly, it is assumed that the relay processing unit-2 312 has m ports P2-1, P2-2, . . . , P2-m and the relay processing unit-n 313 has m ports Pn-1, Pn-2, . . . , n-m, respectively. A plurality of ports are interfaces for connecting to the network through lines such as coaxial cables, optical fibers, or the like. A use object and the number of constructions of the ports for the user, stack ports, and the like are not limited.

Each of the relay processing unit-2 312 and the relay processing unit-n 313 also has the same construction as the relay processing unit-1 311 and the number of constructions of the relay processing units themselves is not limited. Therefore, a description will be made in detail hereinbelow with respect to the relay processing unit-1 311. In the search processing unit 320, a VLAN is defined so that each of a plurality of physical ports is handled as a logical port which is identified by a VLAN ID, and its contents can be held in a management table 322. A frame which is received from each port whose VLAN has been defined can be also limited and transferred to another port of the same VLAN by the transfer processing unit 321. When the frames are received through the ports 331 to 333, by learning information of transmitting source addresses of the received frames and reception port information by the search processing unit 320, a correspondence relation between a destination address of the frame which is transmitted and a transmission port is held in the management table 322. A buffer 323 is a memory area for temporarily storing the frame which is transmitted or the received frame until the transferring process is executed upon transmission and reception of the frame.

At the time of the frame transfer, the frame is notified to the search processing unit 320 from the transfer processing unit 321 which received the frame. The search processing unit 320 searches the management table 322, obtains search result information showing a transfer destination of the frame, and notifies the transfer processing unit 321 of it. The transfer processing unit 321 which received the search result information transmits the search result information and the reception frame stored in the buffer 323 to the cross-bar switch 319. The cross-bar switch 319 transmits the search result information and the reception frame to the transfer processing unit 321 of the proper relay processing unit among the relay processing units 311 to 313 in accordance with the search result information. For example, the reception frame in which the reception port is the port P1-1 and the transmission port is the port P2-1 is transmitted from the transfer processing unit 321 of the relay processing unit-1 311 to the transfer processing unit 321 of the relay processing unit-2 312 through the cross-bar switch 319 and is transmitted from the transfer processing unit 321 of the relay processing unit-2 to the network as a destination of the port P2-1.

The switch 301 is constructed as mentioned above.

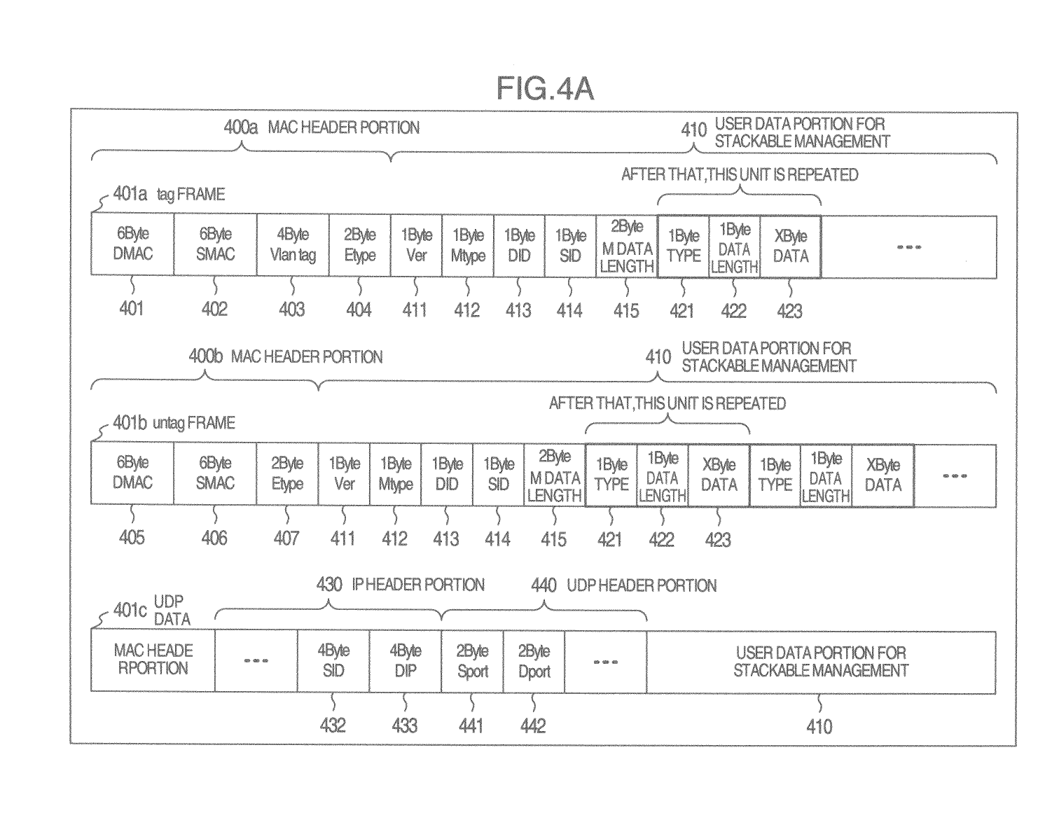

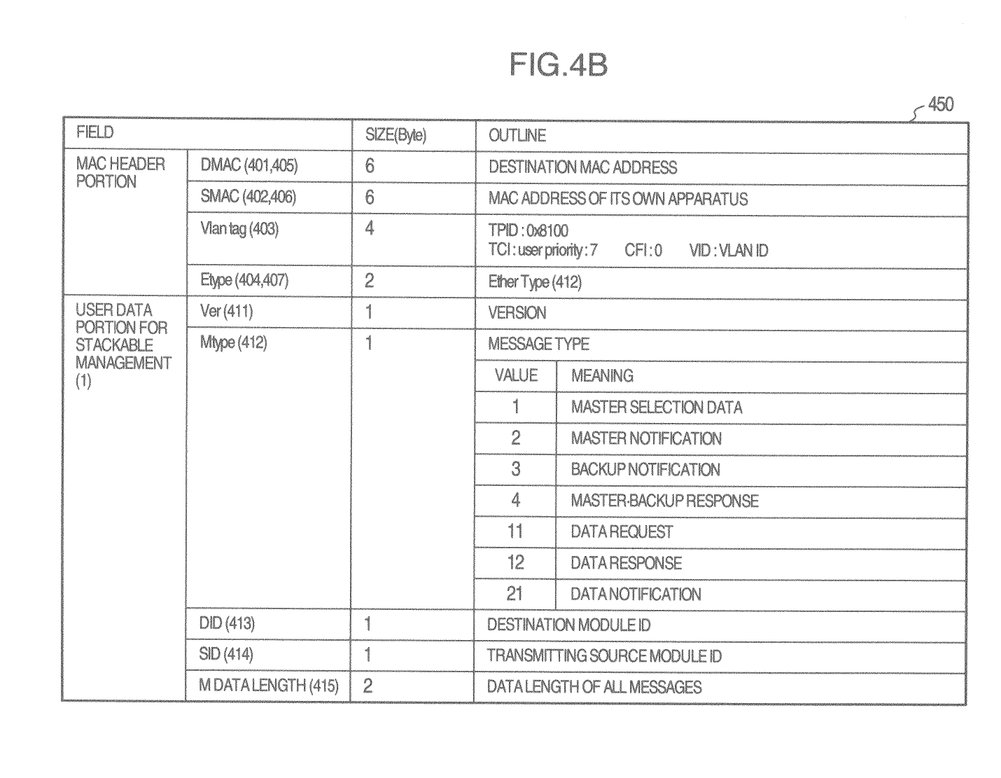

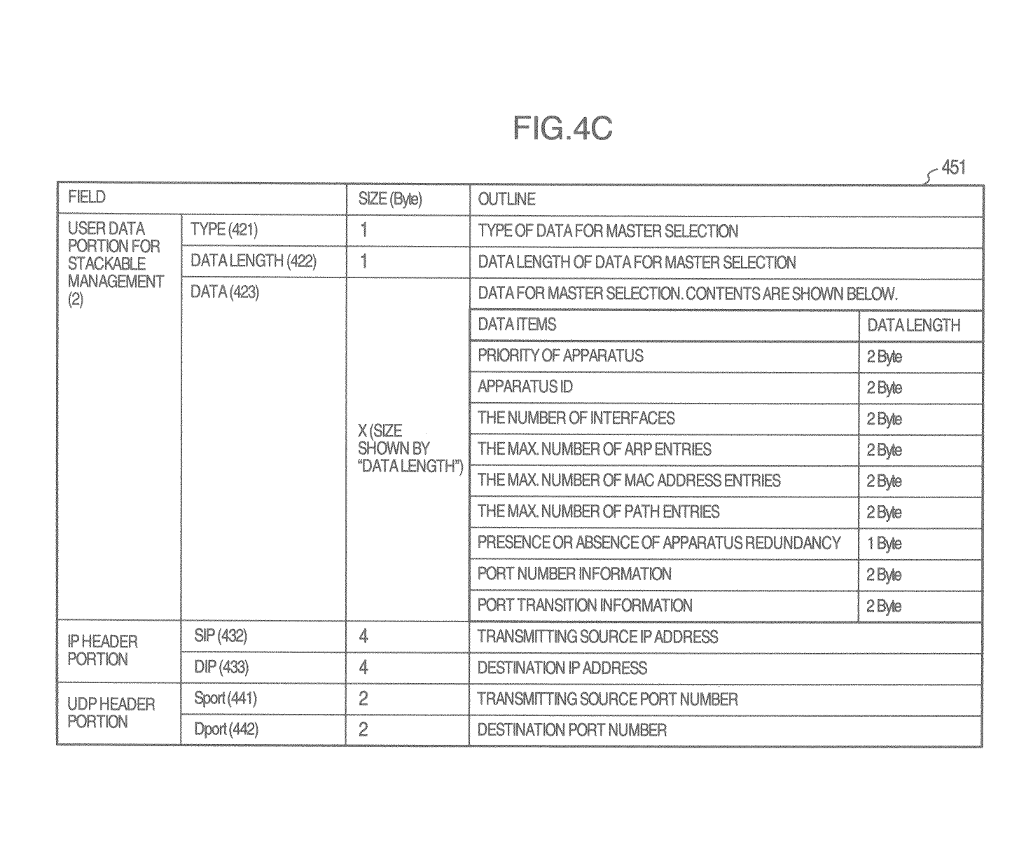

FIGS. 4A, 4B, and 4C are explanatory diagrams of formats of the frames for stackable management which are transmitted and received by the stackable processing units 210 and 310. As a frame for stackable management, any one of a tag frame 401a and an untag frame 401b may be used as data which is superimposed onto an MAC frame. A user data portion 410 for stackable management may be data which is superimposed onto a TCP/IP without limiting onto the MAC frame or may be data which is superimposed onto UDP data 401c. Whether the information is exchanged between the switches by using the tag frame 401a or the untag frame 401b or the information is exchanged by using the TCP or the UDP data 401c can be set from the user by the configuration command or the like. The tag frame 401a is a frame obtained by adding a VLAN TAG field 403 to the untag frame 401b. The P data 401c is data obtained by adding an IP header and a UDP header onto the MAC frame of the tag frame 401a or the untag frame 401b. The stackable user data portion 410 is the same as that of the tag frame 401a or the untag frame 401b.

Contents of each field of the frame for stackable management are shown in a table 450 in FIG. 4B and a table 451 in FIG. 4C. A Layer-2 control frame is used as a frame for stackable management. As destination MAC addresses 401 and 405 of the MAC header, when the master is decided from a plurality of switches just after the activation, since the destination MAC address of the connected apparatus is unknown, in the case where the relevant apparatus transmits first, the unique MAC address which has previously been reserved is used. Filter information is previously set into all of the switches so that the frame in which its unique MAC address is set to a destination can be received. When the frame in which its unique MAC address is set to the destination is received from the partner apparatus, the MAC address of the communication partner apparatus can be recognized by the transmitting source MAC address of the reception frame. Therefore, after the communication partner apparatus was recognized, the destination MAC address corresponding to the partner apparatus to be communicated is allocated. As transmitting source MAC addresses 402 and 406 of the MAC header, the MAC addresses of its own apparatus are used.

In the TCP or the UDP data 401c, in the case where the information is exchanged between the switches, an IP address of its own apparatus is set as a transmitting source IP address 432. As for a destination IP address 433, since an IP address of the apparatus serving as a master before the master is selected is obscure, a subnet broadcast address in which the switch has been connected is used. The subnet broadcast address is designated from the user by the configuration command or the like. After the master was selected, an IP address of the master is used. A transmitting source port number 441 of the UDP header is set to an arbitrary value. As a destination port number 442, a port number which is unique to the user is set so that it can be specified that the next data is the user data portion 410 for stackable management.

As transmitting source MAC addresses 402 and 406 of the MAC header portion, the MAC addresses of its own apparatus are used. The following data is included in the user data portion for stackable management: a version 411 of the frame for stackable management; a message type 412 showing a type indicating whether the frame for stackable management is a frame for master selection, a frame for data request, or the like; a transmitting source module ID 414 serving as a module identifier of a function unit in the apparatus; a destination module ID 413; and a data length 415 of all messages showing a length of the whole user data portion for stackable management. Ordinarily, the module ID of the stackable processing unit 210 is set with respect to the transmitting source module ID 414 and the destination module ID 413. However, it is set in accordance with each use in the case where configuration information is synchronized between the master and the backup, the case where internal log information is sent from a certain module of the member to the relevant module of the master, or the like.

Further, when a value of the message type 412 is equal to 1 showing the master selection data, three kinds of data such as type 421 of data for master selection, a length 422 of data for master selection, and data for master selection 423 are further set. A plurality of sets of those three data can be repetitively set on its unit basis.

The priority of the relevant switch set from the user by the configuration command or the MIB, the apparatus ID to identify the apparatus, and the like are included in the data for master selection 423. When the priority is equal to 0, this means that the switch cannot become the master. Such a condition that the apparatus whose priority is equal to a larger numerical value of 1 or more is liable to become the master with a higher priority is set. If nothing is set by the user, a reference value (default value) is set. Although the apparatus ID is not included in the conditions of master selection, when each of the master, backup, and member is selected, the apparatus ID is used to identify each switch. Similarly, although the port number information and the master transition reference of the data for master selection 423 shown in the table 451 in FIG. 4C are not included either in the conditions of master selection, they are necessary to grasp a connecting state to the network for stackable control.

As other conditions of master selection, the number of interfaces, the maximum number of entries, the maximum number of MAC address entries, and the like can be mer tinned. As for the number of interfaces, the number of interfaces of the relevant switch is set. As for the maximum number of ARP entries and the maximum number of MAC address entries, by collating with a reference value based on a certain definition, the relevant reference value is set. For example, if such a condition that the reference value in which the maximum number of ARP entries is less than 5000 is set to 5 and each time the number of entries increases every 1000 entries after that, 1 is added to the reference value is used as a reference, when a switching capacity of the relevant switch is equal to 6 kiloentries, the reference value is set to 6. Similarly, as for the maximum number of path entries, a reference value is set on the basis of a certain definition.

### (Talking of Redundancy: Check Time is Included)

Further, as additional conditions of master selection, there are presence or absence of apparatus redundancy, and the like. As for these conditions, a reference value based on a certain definition is also set. For example, in the case of a switch (apparatus redundancy) which can perform the redundant operation, the reference value is set to 3. In the case of a switch which cannot perform the redundant operation, the reference value is set to 1.

At the time of the master selection, each of the reference values of the foregoing contents is multiplied and the switch having the largest total value becomes the master. Embodiments of the master selection reference value will be described hereinafter with reference to FIGS. 7A and 7B.

Subsequently, an example in which the master selection data “1” is set as a message type 412 into the user data portion 410 for stackable management and the frame for stackable management is transmitted and received will be described with reference to FIGS. 2 and 4. From the information set by the configuration command or the like, the stackable control unit 213 sets the following items in accordance with the type 421, data length 422, and data 423: the priority of the apparatus; the apparatus ID; the number of interfaces, the maximum number of MAC address entries; the maximum number of entries; the maximum number of path entries, the presence or absence of the apparatus redundancy; the port number information; and the master transition reference. As for the message data length 415, a length of all of the foregoing data items is set. As for the DID 413 (Destination module identification) and the SID (Source module identification) 414, an ID showing the stackable processing unit 210 in FIG. 2 is set. The message type 412 is set to 1 (master selection data). The version 411 is set to 1.

So as to transmit the data to all of the ports which have been set as stack ports by the configuration command or the like, the stackable control unit 213 notifies the stackable frame transmission/reception control unit 215 of the data. The stackable frame transmission/reception control unit 215 confirms the information of all of the stack ports to the stackable function port control unit 216 and notifies the frame transmission/reception control unit 217 of it so as to transmit the data from all of the stack ports. The frame transmission/reception control unit 217 transmits the frames for stackable management in which the data for master selection has been set from all of the stack ports.

For example, if a VLAN 10 was set, the DMAC (Destination MAC address) 401 is set to the unique MAC address. The SMAC (Source MAC address) 402 is set to the MAC address of its own apparatus. In the VLAN tag 403, a TPID is set to 0x8100, a TCI is set to 7, a CFI is set to 0, and a ULAN ID is set to 10 Ethertype 404 is set to a unique type showing the user data for stackable management. The frame transmission/reception control unit 217 transmits the frame to the stack ports 233 and 234.

The switch on the reception side receives the frame at the stack port 233. The transfer processing unit 221 notifies the search processing unit 220 of the frame in order to confirm the destination of the frame. The search processing unit 220 confirms the management table 222. Since the unique MAC address has been set in the DMAC 405 of the frame, the search processing unit 220 determines that the frame is a frame to its own apparatus, and notifies the frame transmission/reception control unit 217 of the data. The frame transmission/reception control unit 217 which received the data decides that it is a frame to the stackable processing unit 210 from the DMAC 405 and the DID 413, and notifies the stackable frame transmission/reception control unit 215 of the frame. The stackable frame transmission/reception control unit 215 confirms that the message type 412 is equal to 1 (master selection data) and notifies the stackable control unit 213 of the frame. The stackable control unit 213 extracts the data from the received data with reference to the type 421, data length 422, data 423, and the like, notifies the stackable information management table control unit 214 of it, and registers into the control information table 800.

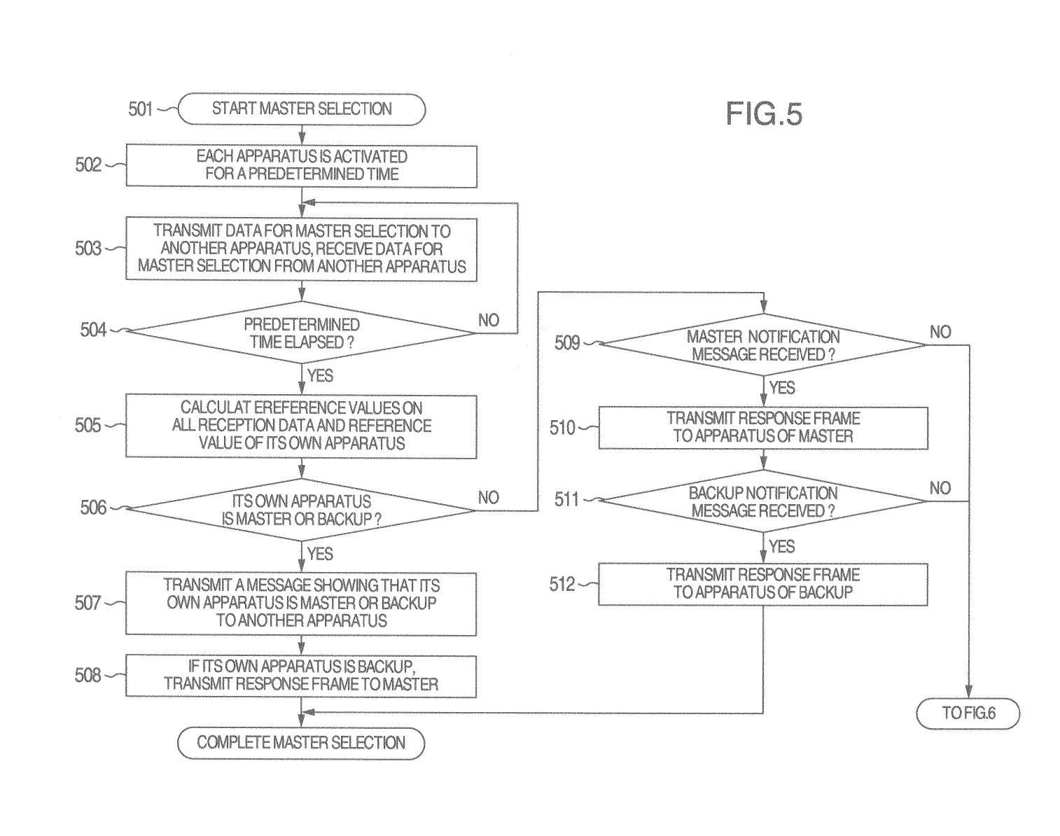

FIG. 5 is a flowchart for master selection and backup selection when a plurality of switches having different enclosing conditions are in a physically connecting state. In the case where the plurality of switches having the different enclosing conditions are physically connected, the master selection and the backup selection (step 501) are executed upon activation of each switch. Each switch is activated for a predetermined time, for example, 20 seconds (step 502).

In step 503, each switch which was activated for the predetermined time sets the value of the message type 412 of the user data portion 410 for stackable management in FIGS. 4A, 4B, and 4C to 1 (master selection data), sets the unique MAC address into the destination MAC address, and transmits the data for master selection of the contents shown in FIGS. 7A and 7B, which will be described hereinafter, to another apparatus from the stack port. In the case of transmitting the data by the TCP or UDP data, the destination IP address 433 is transmitted to the subnet broadcast address to which the switch is connected. If a plurality of ports are connected to the network for stackable control, a message for master selection (frame for stackable management in which the data for master selection has been stored) is transmitted from all of the plurality of ports. Each switch receives the data for master selection. At this time, the received data is registered into the control information table 800 held in the stackable information management table control unit 214.

Subsequently, in step 504, whether or not the predetermined time described in step 502 has elapsed is confirmed at a short period such as 7 seconds. If NO, step 503 is executed again.

After the predetermined time elapsed (YES in step 504), a sum value is calculated from the data for master selection received from each switch and the reference value of its own apparatus is calculated, respectively, and the role (one of the master, backup, and member) of its own apparatus is recognized (step 505). Examples of the calculation based on the reference value will be described hereinafter with reference to FIGS. 7A and 7B.

When the role of its own apparatus is the master (YES in step 506), a frame for stackable management in which the value of the message type 412 of the user data portion 410 for stackable management in FIGS. 4A, 4B, and 4C has been set to 2 (master notification) is formed and transmitted to another apparatus, thereby notifying another apparatus of a fact that its own role is the master (step 507). At this time, if the apparatus IDs overlap, the apparatus ID which does not overlap and is allocated to the relevant switch is also sent together with the frame. Similarly, if the role of its own apparatus is the backup (YES in step 506), a frame for stackable management in which the value of the message type 412 of the user data portion 410 for stackable management has been set to 3 (backup notification) is formed and transmitted to another apparatus, thereby notifying another apparatus of a fact that its own role is the backup (step 507).

The backup apparatus which received the master notification transmitted in step 507, only in the case where the second largest calculation result is obtained in the calculation result of the reference value and it is recognized that the role of its own apparatus is the backup, a frame for stackable management in which the value of the message type 412 of the user data portion 410 for stackable management in FIGS. 4A, 4B, and 4C has been set to 4 (master•backup response) is formed and transmitted to the master, thereby accomplishing a relationship of the master and the backup (step 508).

The master which received the frame for stackable management transmitted in step 508 mutually transmits and receives data in order to synchronize with the backup after that. For example, when the backup requests the data from the master, the value of the message type 412 of the user data portion 410 for stackable management is set to 11 (data request) and a frame for stackable management in which the data to be requested has been set after the data length 415 of all messages is formed and transmitted to the master. The master which received the frame for stackable management sets the value of the message type 412 to 12 (data response) and a frame for stackable management in which the requested data has been set after the data length 415 of all messages is formed and transmitted to the backup. As an example of the data request and the data response, there is a health check (confirmation of life and death) from the master to the backup or each member.

In the case of spontaneously notifying the data, the value of the message type 412 is set to 21 (data notification) and a frame for stackable management in which the data that is spontaneously notified has been set after the data length 415 of all messages is formed and transmitted to the apparatus of the notification destination. As an example of the data notification, a case where an operation incapable state of a certain interface of the switch is sent to the master or the like is considered.

When the value of the message type 412 is equal to one of 2 (master notification), 3 (backup notification), 4 (master•backup response), 11 (data request), 12 (data response), and 21 (data notification), the transmission and reception in a unicast are performed on the basis of the address shown in FIG. 8.

Subsequently, if the role of its self apparatus is the member in step 506 (NO in step 506), the reception of a master notification message which is transmitted in step 507 is waited for a predetermined time (step 509).

When the master notification message is received (YES in step 509), only in the case where the first or second largest calculation result is not obtained in the calculation result of the reference value and it is recognized that the role of its own apparatus is the member and the apparatus which has transmitted the master notification message coincides with the apparatus in which the result of the calculation performed by itself is largest, a frame for stackable management in which the value of the message type 412 of the user data portion 410 for stackable management has been set to 4 (master•backup response) is formed and transmitted to the master, thereby accomplishing a relationship of the master and the relevant member (step 510).

Similarly, the reception of a backup notification message which is transmitted in step 507 is waited for a predetermined time (step 511).

When the backup notification message is received (YES in step 511), only in the case where the first or second largest calculation result is not obtained in the calculation result of the reference value and it is recognized that the role of its own apparatus is the member and the apparatus which has transmitted the backup notification message coincides with the apparatus in which the result of the calculation performed by itself is the second largest value, a frame for stackable management in which the value of the message type 412 of the user data portion 410 for stackable management has been set to 4 (master•backup response) is formed and transmitted to the backup, thereby accomplishing a relationship of the backup and the relevant member (step 512).

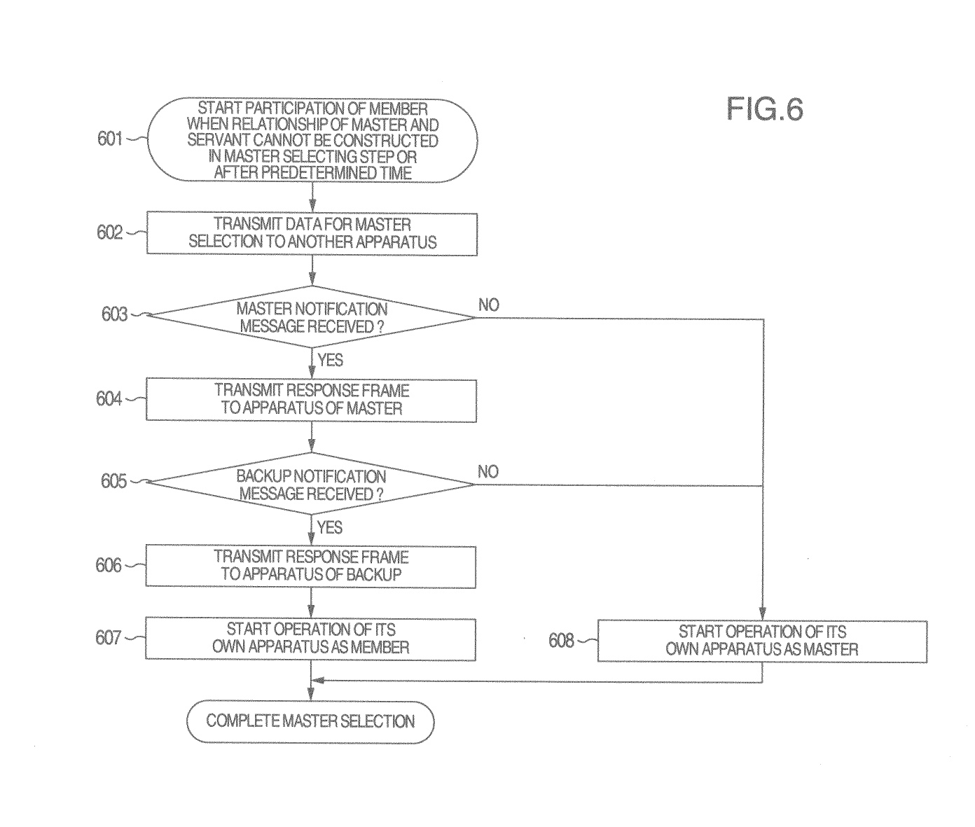

Subsequently, FIG. 6 will be described. FIG. 6 is a flowchart showing processes in the case where the master notification message or the backup notification message cannot be received for the predetermined time in step 509 or 511 in FIG. 5, in the case where a master•backup response message cannot be received and a connecting relation with another switch cannot be constructed, or in the case where the apparatus newly participated in the network for stackable control as a switch over the predetermined time upon activation. Therefore, in the case of newly participating in the network for stackable control, it is a prerequisite condition that the switches of the master and the backup already exist.

First, the data for master selection is transmitted to another apparatus in a manner similar to step 503 in FIG. 5 (step 602). This means that in the case of newly participating as a switch into the existing switch stack after the elapse of the predetermined time, it is shown that the message is transmitted just after the activation. A case where in spite of a fact that the data for master selection was transmitted within the predetermined time after the activation, the relationship of the master and the backup or the like cannot be constructed.

Subsequently, whether or not the master notification message has been received is confirmed (step 603). In the case of newly participating in the switch stack, the master which received the data for master selection in step 602 immediately transmits the master notification message in a manner similar to step 507 in FIG. 5.

When the master notification message from the master is received (YES in step 603), a response frame is transmitted to the switch of the master in a manner similar to step 510 in FIG. 5 (step 604). Thus, the relationship of the master and the member can be constructed.

Subsequently, in a manner similar to step 507 in FIG. 5, the backup which received the data for master selection in step 602 immediately transmits the backup notification message to the switch which newly participates. In the case where the backup notification message from the backup is received (YES in step 605), the response frame is transmitted to the switch of the backup in a manner similar to step 512 in FIG. 5 (step 606). Thus, since the relationship of the backup and the member can be constructed and its own switch starts the operation as a member (step 607).

When the master notification message cannot be received in step 603 or when the backup notification message cannot be received in step 604, it is recognized that the switches other than its own switch do not exist, and its own switch starts the operation as a master (step 608).

Subsequently, the master selection reference value will be described. FIG. 7A is an explanatory diagram showing an example of the master selection reference value in FIG. 1A. In a table 710, an axis of ordinate indicates master selection items and an axis of abscissa indicates setting values of an apparatus unit of the switches 111 to 114 and their reference values.

Each master selection item will now be described. As for the priority (a) of the apparatus, since there is no setting value by the configuration command or the like, it is set to the same default reference value in all of the switches. As for the apparatus ID, similarly, since it is not set in all of the switches, the apparatus ID is allocated to each switch by allocating values from 1 in ascending order from the small MAC address so as not to have the same apparatus ID. This value is not included in the calculation of the reference value. Subsequently, as for the number of interfaces (b), the number of ports in each switch is set to a setting value and the reference value is also set to the same value. The maximum number of entries (c) is defined in such a manner that each time the setting value increases every kiloentries, 1 is added to the reference value. The maximum number of MAC address entries (d) is defined in such a manner that each time the setting value increases every 10 kiloentries, 1 is added to the reference value. The maximum number of path entries (e) is defined so that 1 is added to the reference value one by one on a unit basis of 50 kiloentries in such a manner that when the setting value is less than 1 to 50 kiloentries, the reference value is equal to 1 and when the setting value is 50 kiloentries or more and is less than 100 kiloentries, the reference value is equal to 2. As for the presence or absence of the apparatus redundancy (f), in the case of the switch (apparatus redundancy) which can perform the redundant operation, the reference value is set to 3, and in the case of the switch which cannot perform the redundant operation, the reference value is set to 1.

In step 505 in FIG. 5, each switch calculates a sum value of (a) to (f) on the basis of the data for master selection received from another apparatus and the setting information of its own apparatus. The switch having the largest sum value plays the role of the master. The switch having the second largest sum value plays the role of the backup. Other switches play the role of the member. With respect to the master transition reference set to the user by the configuration command or the like, it is also confirmed. Each switch confirms whether only the switch having the same enclosing condition as that of the switch having the enclosing condition larger than the data of the master transition reference included in the data for master selection plays the role of the backup or the switch stack is constructed in accordance with the switch having the enclosing condition which is not so large. In the former case, since the switch having the same value as that of the switch 114 does not exist, if the switch 114 cannot play the role of the master due to an internal obstruction or the like, it is regarded that the switch stack is set into the operation incapable state. In the latter case, the switch 114 operates in accordance with the enclosing condition of the switches 112 and 113 having the enclosing condition which is not so large. In this case, in each switch, a guard setting is made so that the stackable control unit 213 in FIG. 2 operates in accordance with the enclosing condition of the switches 112 and 113 at the time of the registration into the management table 222.

FIG. 7B is an explanatory diagram showing an example in the case where the priority is changed in FIG. 7A. In a table 720, as a result that the priority of the apparatus is defined to 2000 by the switch 111, the switch 111 becomes the master and the switch 114 operates as a backup. In this manner, the user can also set an arbitrary priority every apparatus.

Subsequently, an example of a Layer-2 relay by the switch stack 110 will be described with reference to FIG. 1C. FIG. 1C is an explanatory diagram of the Layer-2 relay using a trunk port function based on the construction of FIG. 1A. FIG. 1C shows a state where a network 161 of the VLAN 10 is set to the ports for the user P11, P14, and P31 of the switch stack 110 and a network 162 of the VLAN 30 is set to the ports for the user P11 and P41. At this time, in order to realize the Layer-2 relay even between the switches having the different enclosing conditions, all of the stack ports constructing the network 163 for stackable control of the VLAN 4095 are set to trunk ports which participate in all of the VLANs set by the user. In the case of FIG. 1C, they are set as trunk ports of the VLAN 10 and the VLAN 30. Even if all of the ports of the network 163 for stackable control are set as trunk ports, by shutting off the communication by setting the port P12 into a non-operating state 164, Layer-2 communication 165 of the VLAN 10 and Layer-2 communication 166 of the VLAN 30 can be realized even between the switches having the different enclosing conditions.

In the switch having the small number of enclosing conditions, the maximum number of P entries and the maximum number of MAC address entries are smaller than those of the switch having the large number of enclosing conditions. Therefore, when a packet is transferred, there is a case where a destination MAC address of this packet is not learned in hardware. In such a case, however, a flooding process is executed from each port in the same VLAN.

Even if a communication obstruction occurred in the network 163 for stackable control, there is also a case where the communication can be resumed by resetting the non-operating state 164 of the port P12. For example, in the case where the cable between the ports P13 and P32 was cut and the communication obstruction occurred, the communication obstruction also occurs in the Layer-2 communication 165 of the VLAN 10 and the Layer-2 communication 166 of the VLAN 30. However, the communication is resumed by resetting the non-operating state 164 of the port P12. Specifically speaking, the VLAN 10 can communicate by passing through the ports P12, P22, P23, P42, P43, P33, and P31 from the port P14 or P11, and the VLAN 30 can communicate by passing through the ports P11, P12, P22, P23, P42, and P41

To assure a communication path, management of the ports which are set into the non-operating state on a VLAN unit basis is made by the stackable function port control unit 216 in FIG. 2.

Subsequently, a second embodiment of the Layer-2 relay will be described with reference to FIG. 1D. FIG. 1D is an explanatory diagram of the Layer-2 relay using a VLAN tunneling function based on the construction of FIG. 1A. FIG. 1D shows a state where the network 161 of the VLAN 10 is set to the ports for the user P11, P14, and P31 of the switch stack 110 and the network 162 of the VLAN 30 is set to the ports for the user P11 and P41. In a manner similar to FIG. 1C, in order to realize the Layer-2 relay even between the switches haying the different enclosing conditions, in the communication of the VLAN 10 and the VLAN 30, a setting for tunneling by using the network 163 for stackable control of the VLAN 4095 is made. Specifically speaking, when the VLAN is set in a plurality of ports, a setting of tunnels which connect the set switches is made by the stack port. In FIG. 1D, tunnels 1700, 1710, 1720, and 1730 are illustrated in FIG. 1D.

The tunnel settings in the cases of the VLAN 10 and the VLAN 30 are summarized in a table 174. Since the VLAN 10 is set in the switches 111 and 113, a tunnel connecting the switches 111 and 113 is set between the ports P32 and P13 and between the ports P33 and P12. Similarly, since the VLAN 30 is set in the switches 111 and 114, a tunnel connecting the switches 111 and 114 is set between the ports P43 and P13 and between the ports P42 and P12.

In a manner similar to FIG. 1C, by shutting off the communication by setting the port P12 into the non-operating state 164, the Layer-2 communication 165 of the VLAN 10 and the Layer-2 communication 166 of the VLAN 30 perform the Layer-2 relay without looping even between the switches having the different enclosing conditions.

At this time, since the shortest communication path is selected, in the search processing unit 220 in FIG. 2 and the search processing unit 320 in FIG. 3, processes are executed in such a manner that when deciding which one of a plurality of tunnel settings is preferentially used, the priority is enabled to be set, and at the time of the Layer-2 relay, if both of the communication paths in a plurality of tunnel settings are in a state where they can be used, the tunnel having the high priority is used. When explaining in the VLAN 10, in the two tunnel settings between the ports P32 and P13 and between the ports P33 and P12, since he shortest communication path is the path between the ports P32 and P13, the priority of this tunnel is set to be high.

In a manner similar to FIG. 1C, in the switch having the small number of enclosing conditions, the maximum number of P entries and the maximum number of MAC address entries are smaller than those of the switch having the large number of enclosing conditions. Therefore, when a packet is transferred, there is a case where the destination MAC address of this packet is not learned in the hardware. In such a case, however, the flooding process is executed to each port in the same VLAN.

Even if the communication obstruction occurred in the network 163 for stackable control, the communication can be resumed by resetting the non-operating state 164 of the port P12 in substantially the same manner as that in FIG. 1C.

The tunnel setting and the management of the ports are performed by the stackable function port control unit 216 in FIG. 2.

In the embodiment, since the switch stack is constructed by connecting various switches having the different enclosing conditions thereto, as for the Layer-2 relay portions, there are various connecting methods such as case of FIG. 1C in which all ports of the network for stackable control are set to the trunk ports, case of FIG. 1D in which a VLAN tunneling is set, and the like. However, since the network for stackable control is effectively constructed while avoiding restricting items existing depending on the switch, the user is allowed to select a proper one of the connecting methods by using the configuration command or the MIB.

Subsequently, an embodiment of a Layer-3 relay will be described with reference to FIG. 1E. FIG. 1E is an explanatory diagram of the Layer-3 relay using the trunk port function based on the construction of FIG. 1A. In the embodiment, the Layer-3 relay in the case where a switch stack is constructed between the switches having the different enclosing conditions is executed by the switch having the large enclosing condition selected as a master.

In FIG. 1E, processes are executed in such a manner that communication 181 by the Layer-2 relay is made from the VLAN 10 to the switch 114 having the large enclosing condition, in the switch 114, processes are executed to the VLAN 30, and communication 182 by the Layer-2 relay is made from the switch 114 to the port P11 of the switch 111. As for the Layer-2 relay portions, the Layer-3 communication 181 and 182 is realized irrespective of use of any one of the case of FIG. 1C in which all of the ports of the network for stackable control are set to the trunk ports and the case of FIG. 1D in which the VLAN tunneling is set.

The Layer-3 relay process in the switch 114 will now be described with reference to FIG. 2. The switch 114 as a master sets Layer-3 path information obtained by a routing protocol process and a static path setting into the management table 222 and, at the same time, notifies only the switch 111 which plays the role as a backup of the path information and does not notify the switches 112 and 113 as members. In the switch 111 of the backup, the path information is not set into the management table 222 but merely holds the notified path information and does not execute the actual. Layer-3 relay operation. Therefore, the switches 111, 112, and 113 execute only the Layer-2 relay operation. When the switch 114 as a master enters a communication disable state due to an obstruction, the switch 111 of the backup discriminates whether or not it takes over the role of the master on the basis of the information of the master transition reference. In the case of taking over the role of the master, the Layer-3 path information which has merely been held is set into the management table 222, the routing protocol process which has already been set by the configuration command or the like is started, the static path setting is made, and the Layer-3 relay process is started.

Processes which are executed by the switch of the master for performing the Layer-3 relay will be described as such processes that a Layer-3 packet in which the VLAN has been set is received by the stack port 233 and a Layer-3 packet in which the VLAN 30 has been set is transmitted from the stack port 234. In order to execute the frame process of Layer 2, the data received by the stack port 233 is notified to the transfer processing unit 221. In order to confirm the destination of the Layer-2 frame, the transfer processing unit 221 notifies the search processing unit 220 of the data. In the search processing unit 220, the management table 222 is confirmed. If the MAC address of its own apparatus has been set as a destination MAC address of such a frame and an IP header could be confirmed from Ethertype, it is confirmed that the relevant frame is a Layer-3 packet toward the network of the VLAN 30 on the basis of a destination IP address stored in the IP header. Transmission data to the VLAN 30 is set by the transfer processing unit 221 and transmitted from the stack port 234.

Subsequently, an embodiment in the case where a link aggregation over the switches in the switch stack has been set will be described with reference to FIG. 1F. In the switch stack 110 in FIG. 1F, by the switches 113 and 114 having the different enclosing conditions, another switch 173 which does not construct the switch stack 110 is enclosed. A terminal 172 is connected to the switch 173. The switch 173 and the switch stack 110 are connected by two cables and a link aggregation 190 over the switches 113 and 114 is set. A VLAN 10 1740 is set to the ports for the user P31 and P41 constructing the link aggregation.

When the terminal 172 communicates with a terminal 171 connected to the LAN 1, the packet is transmitted to the switch stack 110 from the port constructing the link aggregation 190. In the switch stack 110, the packet is received by the port for the user P31 or P41 constructing the link aggregation 190. Since the link aggregation is set between the switch 173 and the switch stack 110, for example, when the terminal 172 communicates with the terminal 171 through the port for the user P31, if the port for the user P31 enters a link incapable state, the terminal 172 can immediately continuously communicate with the terminal 171 through the port for the user P41

The operation of the stackable processing unit 210 of each of the switches 113 and 114 will now be described with reference to FIG. 2. In the stackable processing unit 210 of the switch 114 as a master, a command setting by the user for setting the ports for the user P31 and P41 in FIG. 1F to the link aggregation 190 is received by the command control unit 211 and notified to the stackable control unit 213. The stackable control unit 213 of the switch 114 as a master forms a frame for stackable management in which the value of the message type 412 in FIG. 4B has been set to 21 (data notification) by using the stackable frame transmission reception control unit 215, and notifies the stackable control unit 213 in the switch 113 having the port for the user P31 constructing the link aggregation 190.

The stackable control unit 213 of each of the switches 113 and 114 sets the information of the link aggregation 190 into the management table 222. At this time, a fact that the ports for the user P13 and P14 have been set to the same link aggregation and their link-up has been performed is notified to the stackable function port control unit 216 and the stackable control unit 213 through the port control unit 218. The information of the link aggregation 190 is also notified to the stackable information management table control unit 214 and stored.

The stackable control unit 213 of the switch 114 as a master forms a frame for stackable management in which the value of the message type 412 in FIG. 4B has been set to 21 (data notification) by using the stackable frame transmission/reception control unit 215, and notifies the stackable control unit 213 in each of the switches 111 and 112 of a fact that the VLAN 10 174 has been added as notification information from the master to the member. All of the stackable control units 213 including the stackable control unit 213 of the switch 114 set the information regarding the VLAN 10 174 into the management table 222 of the search processing unit 220 of the relay processing unit 203 for the purpose of the Layer-3 relay.

Processes in the case where one of the ports for the user P31 and P41 constructing the link aggregation 190 has entered the operation incapable state will now be described. When the port for the user P31 in FIG. 1F enters the link incapable state, the port control unit 218 of the switch 113 notifies the stackable control unit 213 of a fact that the port for the user P31 has entered the operation incapable state. The stackable control unit 213 which received the notification deletes the VLAN information regarding the port for the user P31 from the management table 222. Further, the stackable control unit 213 of the switch 113 forms a frame for stackable management in which the value of the message type 412 in FIG. 4B has been set to 21 (data notification) by using the stackable frame transmission/reception control unit 215, and notifies the stackable control unit 213 in the switch 114 as a master. In order to continue the communication of the terminals 172 and 171, the stackable control unit 213 of the switch 114 which received the notification holds the settings in the management table 222 as they are, leaves the VLAN information regarding the port for the user P41, notifies the stackable information management table control unit 214 of a fact that the port for the user P31 has entered the operation incapable state, and stores it. Thus, the communication of the terminals 171 and 172 is continued through the port for the user P41.

Subsequently, when the port for the user P41 has further entered the link incapable state, the port control unit 218 of the switch 114 notifies the stackable control unit 213 of a fact that the port for the user P41 has entered the operation incapable state. The stackable control unit 213 which received the notification deletes the VLAN information regarding the port for the user P41 from the management table 222. Further, the stackable control unit 213 of the switch 114 notifies the stackable information management table control unit 214 of a fact that the port for the user P41 has entered the operation incapable state, and stores a fact that both of the ports for the user P31 and P41 have entered the operation incapable state. Further, the stackable control unit 213 forms a frame for stackable management in which the value of the message type 412 in FIG. 4B has been set to 21 (data notification) by using the stackable frame transmission/reception control unit 215, and notifies the stackable control unit 213 in each of the switches 111, 112, and 113 of a fact that the VLAN 10 174 has been deleted as notification information from the master to the member. The stackable control unit 213 of each of the switches 111, 112, and 113 deletes the information of the VLAN 10 174 from the management table 222. Thus, the communication of the terminals 171 and 172 is interrupted.

It should be further understood by those skilled in the art that although the foregoing description has been made on embodiments of the invention, the invention is no limited thereto and various changes and modifications may be made without departing from the spirit of the invention and the scope of the appended claims.

1. A network switch which is connected to at least one or more other switches having different enclosing conditions and virtually constructs one switch stack, comprising:
a frame transmission/reception control unit for receiving a frame for stack management including information showing the enclosing conditions of the other switches from the one or more other switches constructing said switch stack; and
a stackable processing unit for comparing the enclosing conditions of the other switches with an enclosing condition of its own switch on the basis of the information showing the enclosing conditions of the other switches included in the frame for stack management received by said frame transmission/reception control unit and information showing the enclosing condition of its own switch and selecting the switch having the largest enclosing condition as a master apparatus for managing said switch stack.

2. A network switch according to claim 1, wherein said stackable processing unit selects, as a backup apparatus, the switch having the same enclosing condition as that of the switch selected as said master apparatus or the switch having the second largest enclosing condition.

3. A network switch according to claim 2, wherein in the case where said master apparatus or the backup apparatus having the same enclosing condition as that of the master apparatus enters a state where it cannot communicate and the switch having the same enclosing condition as that of the master apparatus does not exist among the switches constructing said switch stack, said stackable processing unit regards that said switch stack is in an operation incapable state.

4. A network switch according to claim 1, wherein the switch operates in accordance with the enclosing condition of the switch having the smallest enclosing condition among all of the switches constructing said switch stack.

5. A network switch according to claim 1, wherein said enclosing condition includes at least one of a priority of the switch, the number of interfaces, the maximum number of ARP entries, the maximum number of MAC address entries, and the maximum number of path entries.

6. A network switch according to claim 1, further comprising a relay processing unit for relaying a packet, and
wherein said relay processing unit performs a Layer-2 transfer of the received packet and, only when its own switch is selected as a master apparatus by said stackable processing unit, said relay processing unit performs a Layer-3 transfer.

7. A network switch according to claim 2, wherein the switch operates in accordance with the enclosing condition of the switch having the smallest enclosing condition among all of the switches constructing said switch stack.

8. A network switch according to claim 2, herein said enclosing condition includes at least one of a priority of the apparatus, the number of interfaces, the maximum number of entries, the maximum number of MAC address entries, and the maximum number of path entries.

9. A network switch according to claim 3, wherein said enclosing condition includes at least one of a priority of the apparatus, the number of interfaces, the maximum number of ARP entries, the maximum number of MAC address entries, and the maximum number of path entries.

10. A network switch according to claim 4, wherein said enclosing condition includes at least one of a priority of the apparatus, the number of interfaces, the maximum number of ARP entries, the maximum number of MAC address entries, and the maximum number of path entries.

11. A network switch according to claim 2, further comprising a relay processing unit for relaying a packet, and
wherein said relay processing unit performs a Layer-2 transfer of the received packet and, only when its own switch is selected as a master apparatus by said stackable processing unit, said relay processing unit performs a Layer-3 transfer.

12. A network switch according to claim 3, further comprising a relay processing unit for relaying a packet, and
wherein said relay processing unit performs a Layer-2 transfer of the received packet and, only when its own switch is selected as a master apparatus by said stackable processing unit, said relay processing unit performs a Layer-3 transfer.

13. A network switch according to claim 4, farther comprising a relay processing unit for relaying a packet, and
wherein said relay processing unit performs a Layer-2 transfer of the received packet and, only when its own switch is selected as a master apparatus by said stackable processing unit, said relay processing unit performs a Layer-3 transfer.

14. A network switch according to claim 5, further comprising a relay processing unit for relaying a packet, and
wherein said relay processing unit performs a Layer-2 transfer of the received packet and, only when its own switch is selected as a master apparatus by said stackable processing unit, said relay processing unit performs a Layer-3 transfer.
